(19) United States
(12) Patent Application Publication
(10) Pub. No.: US 2016/0248751 A1
(43) Pub. Date: Aug. 25, 2016

(54) CM REGISTRATION METHOD AND APPARATUS

(71) Applicant: Huawei Technologies Co., Ltd., Shenzhen (CN)

(72) Inventors: Xiong Yao, Xi'an (CN); Linli Zhang, Xi'an (CN)

(21) Appl. No.: 15/147,566

(22) Filed: May 5, 2016

Related U.S. Application Data
(63) Continuation of application No. PCT/CN2015/084075, filed on Jul. 15, 2015.

(30) Foreign Application Priority Data
Dec. 4, 2014 (CN) 201410733668.7

(51) Int. Cl. H04L 29/06

(52) U.S. Cl. CPC H04L 63/08; H04L 63/102

(57) ABSTRACT

The present invention provides a cable modem (CM) registration method and apparatus, where the method includes: after obtaining a media access control (MAC) address of a CM, sending, by a cable modem termination system (CMTS), the MAC address of the CM and identification information of the CMTS to an authentication server for performing authentication. By binding the CM to the CMTS, a location in which the CM gets online can be limited, thereby preventing the CM from accessing any CMTS.

### CROSS REFERENCE TO RELATED APPLICATIONS

This application is a continuation of International Application No. PCT/CN2015/084075, filed on Jul. 15, 2015, which claims priority to Chinese Patent Application No. 201410733668.7, filed on Dec. 4, 2014, both of which are hereby incorporated by reference in their entireties.

### TECHNICAL FIELD

The present invention relates to the field of DOCSIS (Data-over-Cable Service Interface Specifications), and in particular, to a CM (Cable Modem) registration method, apparatus, and system.

### BACKGROUND

An MSO (Multiple System Operator) uses a CMTS (Cable Modem Termination System) as a core device to implement a coaxial cable broadband access service. FIG. 1 is a schematic diagram of an existing DOCSIS architecture. In FIG. 1, a CM 10 is connected to a CMTS 12 by using a Cable, and the CMTS 12 is connected to an OSS (Operations Support System) 14 by using a transmission medium such as an optical fiber, where the OSS 14 may include multiple types of servers, including a DHCP (Dynamic Host Configuration Protocol) server, a TFTP (Trivial File Transfer Protocol) server, a RADIUS (Remote Authentication Dial In User Service) server, and the like.

In the architecture in FIG. 1, if the CM 10 needs to activate a Cable service, the CM 10 needs to apply to an MSO operator, and an MSO 14 determines, according to a current service resource, whether to accept the application, where a specific service resource is relevant to a line on a CMTS 12 side, and a line resource differs according to a location of the CMTS 12.

After the application is successful, the MSO 14 locally generates a configuration file of the CM 10, where the configuration file includes SNMP (Simple Network Management Protocol) information and the like.

After being powered on, the CM 10 initiates a registration process, where the process includes:

1. The CM 10 sends a MAC (Media Access Control) address of the CM 10 to the CMTS 12.

2. The CM 10 sends a DHCP request message to a DHCP server in the OSS 14 by using the CMTS 12, so as to request the DHCP server to allocate an IP address and deliver configuration file information. Serving as a relay of the CM 10 and the DHCP server, the CMTS 12 delivers the IP address and the configuration file information to the CM 10 after receiving the IP address and the configuration file information that are delivered by the DHCP server to the CM 10, where the configuration file information includes a file name, address information of a TFTP server storing the configuration file, and the like.

3. The CM 10 requests a configuration file from the TFTP server in the OSS 14 according to the configuration file information.

4. The CM 10 uses information such as SNMP information in the configuration file to initiate a registration process to the CMTS 12, and gets online after registration is successful.

It can be seen from the foregoing procedure that, there is no authentication process in a process in which a CM gets online, and the CM can register and get online successfully as long as a DHCP server has allocated an IP address and delivered a configuration file to the CM. In this way, there is a risk that the CM is counterfeited.

### SUMMARY

An embodiment of the present invention provides a CM registration method in a DOCSIS system, including:

receiving, by a CMTS, a MAC address of a CM;

sending, by the CMTS, the MAC address of the CM and identification information of the CMTS to an authentication server;

receiving, by the CMTS, an authentication success response message of the authentication server, and forwarding a DHCP request message of the CM to a DHCP server;

receiving, by the CMTS, an IP address and configuration file information that are delivered by the DHCP server, and forwarding the IP address and the configuration file information to the CM; and receiving, by the CMTS, a registration request message of the CM, and returning a registration success response message to the CM.

An embodiment of the present invention provides a CM registration method in a DOCSIS system, including:

receiving, by a CMTS, a Media Access Control MAC address of a CM;

receiving, by the CMTS, a DHCP request message of the CM, and forwarding the DHCP request message to a DHCP server;

receiving, by the CMTS, an IP address and configuration file information that are delivered by the DHCP server, and forwarding the IP address and the configuration file information to the CM;

receiving, by the CMTS, a registration request message of the CM, and sending the MAC address of the CM and identification information of the CMTS to an authentication server; and

receiving, by the CMTS, an authentication success response message of the authentication server, and returning a registration success response message to the CM.

An embodiment of the present invention provides a CMTS, including:

an authentication module, configured to receive a MAC address of a CM, and send the MAC address and identification information of the CMTS to an authentication server;

a DHCP processing module, configured to receive a DHCP request message of the CM, forward the DHCP request message to a DHCP server after the authentication module receives an authentication success response message of the authentication server, receive an IP address and configuration file information that are delivered by the DHCP server, and forward the IP address and the configuration file information to the CM; and

a registration module, configured to receive a registration request message of the CM, and return a registration success response message to the CM.

An embodiment of the present invention provides a CMTS, including:

an authentication module, configured to perform authentication on a CM, including: receiving a MAC address of the CM, and sending the MAC address and identification information of the CMTS to an authentication server;

a DHCP processing module, configured to receive a DHCP request message of the CM, forward the DHCP request message to a DHCP server, receive an IP address and configuration file information that are delivered by the DHCP server, and forward the IP address and the configuration file information to the CM; and

a registration module, configured to receive a registration request message of the CM, instruct the authentication module to initiate an authentication process, and after the authentication module receives an authentication success response message, return a registration success response message to the CM.

According to the method and the apparatus that are provided in the embodiments of the present invention, an authentication process is added in a process in which a CM registers and gets online. By binding the CM to a CMTS, a location in which the CM gets online can be limited, thereby preventing the CM from accessing any CMTS. In addition, by restricting a binding relationship between the CM and the CMTS, a cloned CM can also be prevented from getting online, thereby protecting a line resource of an operator.

### BRIEF DESCRIPTION OF THE DRAWINGS

FIG. 1 is a schematic diagram of an existing DOCSIS architecture;

FIG. 2 is a schematic diagram of a DOCSIS architecture according to the present invention;

FIG. 3 is a flowchart of a method according to an embodiment of the present invention;

FIG. 4 is a flowchart of a method according to another embodiment of the present invention; and

FIG. 5 is a schematic structural diagram of a CMTS according to an embodiment of the present invention.

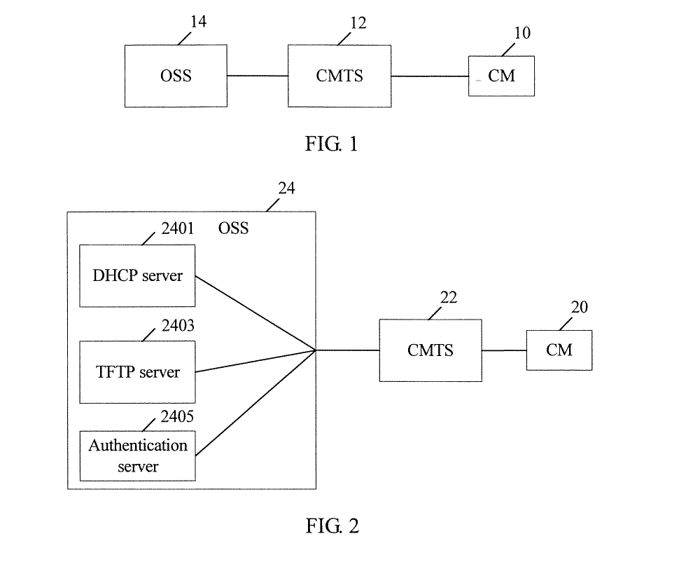

### DETAILED DESCRIPTION

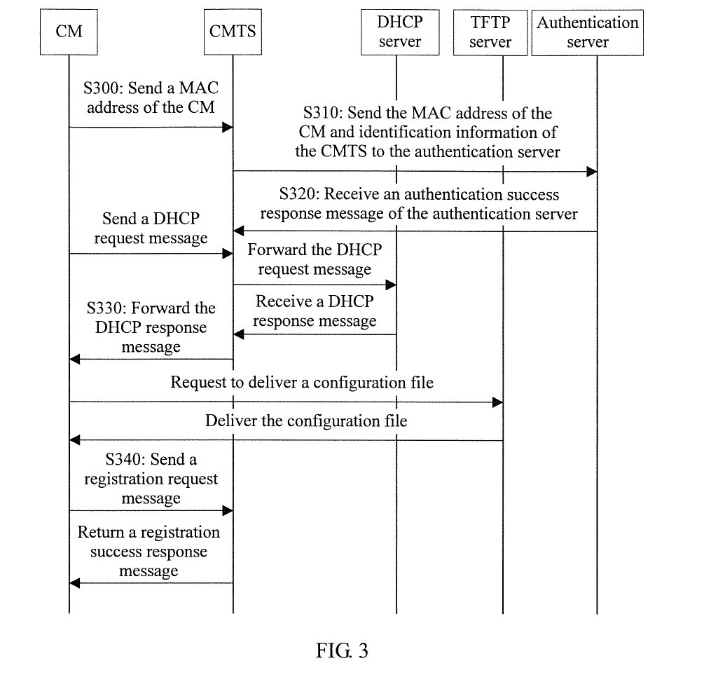

An embodiment of the present invention provides a CM registration method in a DOCSIS system, which is based on an architecture shown in FIG. 2. In FIG. 2, a CM 20 is connected to a CMTS 22 by using a Cable, and the CMTS 22 is connected to an OSS 24 by using a transmission medium such as an optical fiber DSL (Digital Subscriber Line) or a Cable. In an implementation manner, the CMTS 22 may be an independent device. In another implementation manner, the CMTS 22 may also include an OLT and a CMC (Coaxial Media Converter), where the OLT and the CMC are connected by using an optical fiber, and the CMC is connected to the CM 20 by using a Cable. The OSS 24 includes multiple types of servers. As shown in FIG. 2, the OSS 24 includes a DHCP server 2401, a TFTP server 2403, an authentication server 2405, and the like, where the authentication server 2405 may be a RADIUS server, a TACACS (Terminal Access Controller Access Control System) server, or the like, or may include both a RADIUS server and a TACACS server.

Based on the architecture in FIG. 2, the CM registration method provided in this embodiment is shown in FIG. 3, including:

S300: A CMTS receives a MAC (Media Access Control) address of a CM.

The MAC address of the CM may be obtained by the CMTS in multiple manners, for example, may be sent by the CM to the CMTS in a line registration process, or may be separately reported to the CMTS. A specific manner is not limited herein.

In this step, the CMTS may obtain a certificate of the CM, and perform authentication on the CM by using the certificate, where the certificate may be reported to the CMTS by the CM, or may be obtained by the CMTS according to the MAC address of the CM from a server storing the certificate, and so on. An authentication process may be local authentication by the CMTS, such as performing authentication on the certificate reported by the CM by using a valid root certificate, or sending the certificate to a certificate center for performing authentication. If certificate authentication fails, the CMTS may prevent the CM from performing a next procedure, for example, return a failure.

S310: The CMTS sends the MAC address of the CM and identification information of the CMTS to an authentication server.

The CMTS may send the MAC address of the CM and the identification information of the CMTS to the authentication server in a simulation created user manner, where the MAC address of the CM sent to the authentication server is used as a user name and the identification information of the CMTS sent to the authentication server is used as a password, and it may also be that the identification information of the CMTS sent to the authentication server is used as a user name and the MAC address of the CM sent to the authentication server is used as a password.

In a specific implementation manner, the identification information of the CMTS may be a MAC address of the CMTS, or may be a combination of a device identifier of the CMTS and a subrack number, a slot number, and a port number of the CMTS connected to the CM, or the like.

A correspondence between identification information of a CMTS and a MAC address of a CM is preconfigured on the authentication server. The authentication server may perform authentication, by using such a correspondence, on the MAC address of the CM and the identification information of the CMTS that are sent by the CMTS; if such a correspondence exists, an authentication success response message is sent to the CMTS; if such a correspondence does not exist, an authentication failure response message is sent. In an alternative authentication manner, the authentication server may also enable an automatic learning function. For the MAC address of the CM and the identification information of the CMTS that are sent by the CMTS, if the correspondence is new, learning is performed; if the correspondence is not new, dropping is performed. Subsequently, the MAC address of the CM and the identification information of the CMTS that are sent by the CMTS are authenticated by using a correspondence obtained by learning.

S320: The CMTS receives an authentication success response message of the authentication server, and forwards a DHCP request message of the CM to a DHCP server.

The CM sends the DHCP request message to the DHCP server by using the CMTS; if the CMTS receives the authentication success response message of the authentication server, the DHCP request message is forwarded to the DHCP server; if the CMTS does not receive the authentication success response message of the authentication server, a DHCP response message of failing to obtain an IP address is sent to the CM.

S330: The CMTS receives a DHCP response message of the DHCP server, and sends the DHCP response message to the CM.

The DHCP response message includes an IP address allocated by the DHCP server to the CM, configuration file information of the CM, and the like, where the configuration file information includes an IP address of a TFTP server storing a configuration file, a configuration file name, and the like.

The CMTS sends the DHCP response message to the CM. After obtaining the configuration file information, the CM uses the IP address of the TFTP server in the configuration file information to request to download the configuration file from the corresponding TFTP server, where the downloaded configuration file may include service flow configuration information and/or bandwidth configuration information of a related service involved in getting online of the CM, and the bandwidth configuration information includes line configuration, a QoS (Quality of Service) parameter, and the like.

S340: The CMTS receives a registration request message of the CM, and returns a registration success response message to the CM.

The CM uses the service flow configuration information and/or bandwidth configuration information of the related service in the configuration file information to register with the CMTS. After receiving the information, the CMTS returns the registration success response message to the CM.

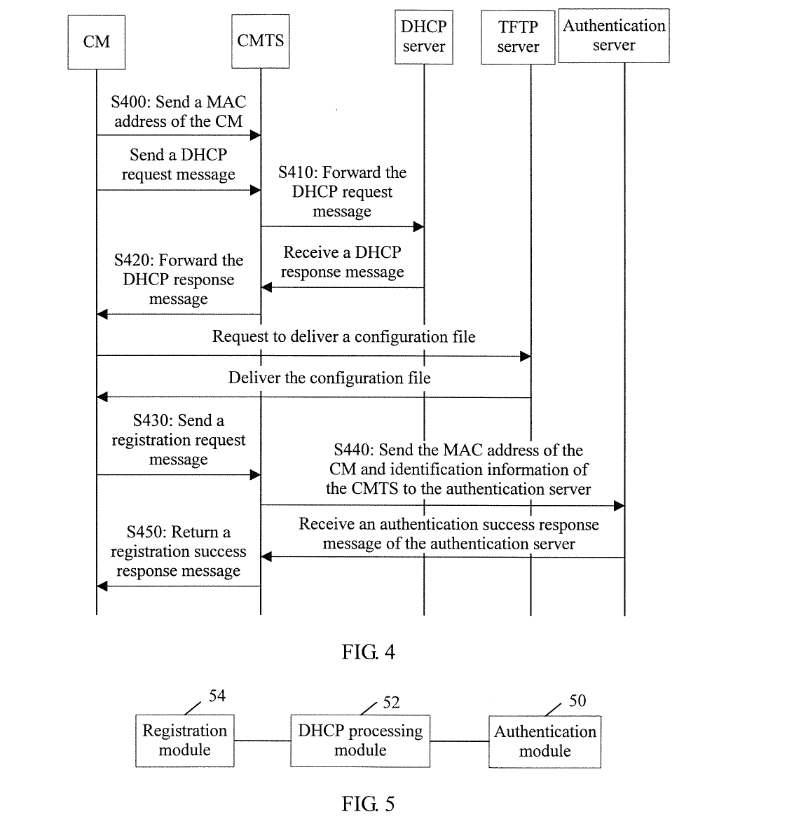

In this embodiment, the CMTS performs the authentication on the CM prior to a DHCP process. In another embodiment, a CMTS may also perform authentication on a CM after the CM obtains a configuration file. A specific process is shown in FIG. 4, including:

S400: A CMTS receives a MAC address of a CM.

This step is similar to S300, and for a specific process, reference may be made to the description of S300.

S410: The CMTS receives a DHCP request message of the CM, and forwards the DHCP request message to a DHCP server.

Different from S320, in S410, the DHCP request message of the CM is directly forwarded, or the DHCP request message of the CM is forwarded when there is certificate authentication and the certificate authentication succeeds in S400.

S420: The CMTS receives a DHCP response message of the DHCP server, and sends the DHCP response message to the CM.

This step is similar to S300, and for a specific process, reference may be made to the description of S330.

S430: The CMTS receives a registration request message of the CM.

S440: The CMTS sends the MAC address of the CM and identification information of the CMTS to an authentication server.

Similar to S310, an example in which the identification information of the CMTS is a MAC address of the CMTS is used. The CMTS may send the MAC address of the CM and the MAC address of the CMTS to the authentication server in a simulation created user manner, where the MAC address of the CM sent to the authentication server is used as a user name and the MAC address of the CMTS sent to the authentication server is used as a password, and it may also be that the MAC address of the CMTS sent to the authentication server is used as a user name and the MAC address of the CM sent to the authentication server is used as a password.

A correspondence between a MAC address of a CMTS and a MAC address of a CM is preconfigured on the authentication server. The authentication server may perform authentication, by using such a correspondence, on the MAC address of the CM and the MAC address of the CMTS that are sent by the CMTS; if such a correspondence exists, an authentication success response message is sent to the CMTS; if such a correspondence does not exist, an authentication failure response message is sent. In an alternative authentication manner, the authentication server may also enable an automatic learning function. For the MAC address of the CM and the MAC address of the CMTS that are sent by the CMTS, if the correspondence is new, learning is performed; if the correspondence is not new, dropping is performed. Subsequently, the MAC address of the CM and the MAC address of the CMTS that are sent by the CMTS are authenticated by using a correspondence obtained by learning.

S450: The CMTS receives an authentication success response message of the authentication server, and returns a registration success response message to the CM.

If the authentication success response message is received, the CMTS returns the registration success response message to the CM, and if the authentication failure response message is received, the CMTS returns a registration failure response message to the CM.

According to the method provided in this embodiment, an authentication process is added in a process in which a CM registers and gets online. By binding a MAC address of the CM and a MAC address of a CMTS, a location in which the CM gets online can be limited, thereby preventing the CM from accessing any CMTS. In addition, by restricting a binding relationship between the CM and the CMTS, a cloned CM can also be prevented from getting online, thereby protecting a line resource of an operator.

An embodiment of the present invention provides a CMTS, as shown in FIG. 5, including: an authentication module 50, a DHCP processing module 52, and a registration module 54.

The authentication module 50 is configured to perform authentication on a CM, including: receiving a MAC address of the CM, and sending the MAC address and identification information of the CMTS to an authentication server.

The DHCP processing module 52 is configured to receive a DHCP request message of the CM, forward the DHCP request message to a DHCP server, receive an IP address and configuration file information that are delivered by the DHCP server, and forward the IP address and the configuration file information to the CM.

The registration module 54 is configured to receive a registration request message of the CM, instruct the authentication module 50 to initiate an authentication process, and after the authentication module 50 receives an authentication success response message, return a registration success response message to the CM.

The authentication module 50 may also perform authentication on a certificate of the CM, including: obtaining the certificate of the CM and performing authentication on the obtained certificate, and the like, which may be specifically: obtaining a certificated reported by the CM or obtaining a certificate from a server storing the certificate, or the like, and sending the obtained certificate to a certificate center for performing authentication, or performing authentication on the obtained certificate by using a locally stored root certificate, or the like.

In another embodiment, before the DHCP processing module 52 receives the DHCP request message of the CM, the authentication module 50 may send the MAC address and the identification information of the CMTS to the authentication server for performing authentication, and forward a subsequent DHCP request message of the CM to the DHCP server after receiving the authentication success response message of the authentication server. In this implementation manner, the registration module 54 returns the registration success response message to the CM after receiving the registration request message.

In a specific implementation manner, the CMTS provided in this embodiment may be an independent device. In this case, the authentication module 50, the DHCP processing module 52, and the registration module 54 may be three independent processors disposed in the CMTS, or may be different modules disposed in one processor, or may be implemented by using a series of software. In another embodiment, the CMTS may also include a CMC and an OLT. If the CMTS includes a CMC and an OLT, the authentication module 50, the DHCP processing module 52, and the registration module 54 may be preferably disposed in the CMC, or may be disposed in the OLT, or may be distributed on the CMC and the OLT.

According to the CMTS provided in this embodiment, authentication may be performed on a CM in a process in which the CM registers and gets online. By binding the CM to a CMTS, a location in which the CM gets online can be limited, thereby preventing the CM from accessing any CMTS. In addition, by restricting a binding relationship between the CM and the CMTS, a cloned CM can also be prevented from getting online, thereby protecting a line resource of an operator.

A person of ordinary skill in the art may understand that all or some of the processes of the methods in the embodiments may be implemented by a computer program instructing relevant hardware. The program may be stored in a computer-readable storage medium. When the program runs, the processes of the methods in the embodiments are performed. The foregoing storage medium may include: a magnetic disk, an optical disc, a read-only memory (ROM), a random access memory (RAN), or the like.

What is disclosed above is merely exemplary embodiments of the present invention, and certainly is not intended to limit the protection scope of the present invention. Therefore, equivalent variations made in accordance with the claims of the present invention shall fall within the scope of the present invention.

What is claimed is:

1. A Cable Modem (CM) registration method in a Data-over-Cable Service Interface Specifications (DOCSIS) system, the method comprising:
receiving, by a cable modem termination system (CMTS), a Media Access Control (MAC) address of a CM;
sending, by the CMTS, the MAC address of the CM and identification information of the CMTS to an authentication server;
receiving, by the CMTS, an authentication success response message of the authentication server, and forwarding a Dynamic Host Configuration Protocol (DHCP) request message of the CM to a DHCP server;
receiving, by the CMTS, an IP address and configuration file information that are delivered by the DHCP server, and forwarding the IP address and the configuration file information to the CM; and
receiving, by the CMTS, a registration request message of the CM, and returning a registration success response message to the CM.

2. The method according to claim 1, wherein:
the authentication server comprises a Remote Authentication Dial In User Service (RADIUS) server; and
sending, by the CMTS, the MAC address of the CM and identification information of the CMTS to an authentication server comprises:
requesting RADIUS authentication from the RADIUS server by using the MAC address of the CM as a user name and using the identification information of the CMTS as a password.

3. The method according to claim 1, wherein:
the authentication server comprises a Terminal Access Controller Access Control System (TACACS) server; and
sending, by the CMTS, the MAC address of the CM and identification information of the CMTS to an authentication server comprises:
requesting TACACS authentication from the TACACS server by using the MAC address of the CM as a user name and using the identification information of the CMTS as a password.

4. The method according to claim 1, wherein before sending, by the CMTS, the MAC address of the CM and identification information of the CMTS to an authentication server, the method further comprises:
obtaining, by the CMTS, a certificate of the CM, performing authentication on the CM by using the certificate, and if the authentication succeeds, sending, by the CMTS, the MAC address of the CM and the identification information of the CMTS to the authentication server.

5. The method according to claim 1, wherein the identification information of the CMTS comprises:
a MAC address of the CMTS; or
a combination of a device identifier of the CMTS and a subrack number, a slot number, and a port number of the CMTS connected to the CM.

6. A Cable Modem (CM) registration method in a Data-over Cable Service Interface Specifications (DOCSIS) system, the method comprising:
receiving, by a cable modem termination system (CMTS), a Media Access Control (MAC) address of a CM;
receiving, by the CMTS, a Dynamic Host Configuration Protocol (DHCP) request message of the CM, and forwarding the DHCP request message to a DHCP server;
receiving, by the CMTS, an IP address and configuration file information that are delivered by the DHCP server, and forwarding the IP address and the configuration file information to the CM;
receiving, by the CMTS, a registration request message of the CM, and sending the MAC address of the CM and identification information of the CMTS to an authentication server; and
receiving, by the CMTS, an authentication success response message of the authentication server, and returning a registration success response message to the CM.

7. The method according to claim 6, wherein:
the authentication server comprises a Remote Authentication Dial In User Service (RADIUS) server or a Terminal Access Controller Access Control System (TACACS) server; and
sending, by the CMTS, the MAC address of the CM and identification information of the CMTS to an authentication server comprises:
performing authentication by the authentication server by using the MAC address of the CM as a user name and using the identification information of the CMTS as a password.

8. A cable modem termination system (CMTS), comprising:
an authentication module, configured to receive a Media Access Control (MAC) address of a cable modem (CM), and send the MAC address and identification information of the CMTS to an authentication server;
a Dynamic Host Configuration Protocol (DHCP) processing module, configured to receive a DHCP request message of the CM, forward the DHCP request message to a DHCP server after the authentication module receives an authentication success response message of the authentication server, receive an IP address and configuration file information that are delivered by the DHCP server, and forward the IP address and the configuration file information to the CM; and
a registration module, configured to receive a registration request message of the CM, and return a registration success response message to the CM.

9. The CMTS according to claim 8, wherein if the CMTS comprises a coaxial media converter (CMC) and an optical line terminal (OLT), and the CMC and the OLT are connected by using an optical fiber, the authentication module, the DHCP processing module, and the registration module are disposed in the CMC.
